(19) United States
(12) Patent Application Publication
(10) Pub. No.: US 2020/0056419 A1
(43) Pub. Date: Feb. 20, 2020

(54) DOOR GUIDE FRAME OF DETACHABLE SEGMENT STRUCTURE FOR SLIDING WINDOWS AND DOORS

(71) Applicant: FILOBE CO., LTD., Daegu (KR)

(72) Inventor: Kwang-Seog LEE, Daegu (KR)

(73) Assignee: FILOBE CO., LTD., Daegu (KR)

(21) Appl. No.: 16/345,827

(22) PCT Filed: Oct. 28, 2017
(86) PCT No.: PCT/KR2017/012069

§ 371 Date: Apr. 29, 2019

(30) Foreign Application Priority Data
Oct. 28, 2016 (KR) 10-2016-0142377

(51) Int. Cl. E06B 3/46; E06B 3/263; E06B 9/52; E05D 15/06

(52) U.S. Cl. CPC E06B 3/46; E06B 3/26347; E06B 3/4609; E05Y 2900/148; E05D 15/0621; E05Y 2900/132; E06B 9/52

(57) ABSTRACT

The present invention relates to a door guide frame of a detachable segment structure for sliding windows and doors, in which in order to improve heat insulating performance of the door guide frame, the door guide frame is divided into an outer body portion and an inner body portion and a thermal break is disposed therebetween, and even when a second pocket guide segment accommodated in the inner side surface of the inner body portion and a third pocket guide segment accommodated in the inner side surface of the outer body portion are separated from an upper cap region of an aluminum material and have a lower leg region formed of a thermal break material, a supporting means capable of providing a good supporting force for the lower leg region formed of such thermal break material is provided without affecting the heat insulating performance of the door guide frame.

### TECHNICAL FIELD

The present invention relates to a door guide frame of detachable segment structure for guiding the sliding movement of a roller device which supports a sliding window and provides a sliding opening/closing operation and, more particularly, to a sliding window installation structure which is capable of: stably supporting and moving a sliding window or a horizontal sliding window (hereinafter, generally referred to as a “sliding window”) on a bottom surface and a top surface on which the sliding window is installed; reducing an installation space by minimizing the size of a door guide frame and a roller device for supporting a heavy sliding window, thereby obtaining a wider open view when applied to a window; and employing a structure comprising a door guide frame of detachable segment structure which prevents a door guide rail from protruding upward from the bottom surface of a window frame so as to prevent occurrence of a passage obstacle which may be caused when the door guide rail protrudes on a moving passage while the window is opened, as well as to provide a good aesthetic appearance, thereby providing excellent applicability to various fields.

### BACKGROUND ART (PRIOR ART)

The applicant of the present application has proposed an invention disclosed in Korean Patent Application No. 10-2012-0047789 (filed on May 26, 2012) with respect to a sliding window installation structure including a door guide frame of such a separable and detachable segment structure. This Korean patent application has been disclosed in Korean Patent Laid-Open Publication No. 10-2013-0124444 (published on Nov. 14, 2013) and Korean Patent Publication No. 10-1367835 (issued on Mar. 3, 2014) It has also been published as WIPO Open Publication WO2013/168943A1 (published Nov. 14, 2014) and US Patent Application Laid-Open No. 2015-0121764 A1 (published May 7, 2015).

In the sliding window installation structure according to the prior art of the applicant of the present application, as shown in FIGS. 1 to 4 attached herewith, there is shown a door guide frame 100 for guiding a sliding window 400 at the inner and outer sides (front side and back side/inner and outer surfaces) of the sliding window 400, in which a pocket guide 130 is detachably attached to a main body portion 120 of the door guide frame 100. The pocket guide 130 includes a pocket guide segment (130; 130\textcircled{a} or 130\textcircled{b}; 130-1, 130-2, 130-3, and 130-4) detachable from the main body portion 120 of the door guide frame 100. Therefore, there is shown the door guide frame 100 having a structure in which the pocket guide segments (130; 130\textcircled{a} or 130\textcircled{b}) are detachably and continuously installed on both inner and outer surfaces of the sliding window 400 along a moving direction of a roller guide rail 110. However, an aluminum material can be generally used as a basic material for providing the door guide frame 100 having a detachable segment structure that forms such a structure. In the case of such an aluminum material, as shown in the cross-sectional view of the operating state of FIGS. 1 to 4 and in a partially exploded perspective view of FIG. 2 (a perspective view at a B-B′ broken line location of FIG. 4), it is more advantageous to employ a structure in which the main body portion 120 of the door guide frame 100 is divided into two portions of the inner side and the outer side of the window and a heat bridge blocking member 120m (thermal bridge breaker) is disposed in a middle portion between the two portions. Moreover, a leg region 130m may be preferably formed of a heat-transmission-blocking material separated from a remaining upper cap region 130a made of aluminum.

However, when the main body portion 120 of the door guide frame 100 is arranged into two parts of an outer main body portion 120-out and an inner main body portion 120-in while the heat bridge blocking member 120m is disposed in the middle of the two parts as shown in FIG. 5, four pocket guide segments (130: 130\textcircled{a} or 130\textcircled{b}); 130-1, 130-2, 130-3, and 130-4) should be detachably installed on the main body portion 120 of the door guide frame 100, i.e. on the base surfaces of the outer main body portion 120-out and the inner main body portion 120-in. To this end, a partition wall 121 is protruded and formed on both sides of the roller guide rail 110 along the moving direction of the roller guide rail 110 to form a receiving portion 122 into which the pocket guide segment 130 can be inserted. Thereby, a leg portion of a first pocket guide segment 130-1 is inserted into an inner side of the receiving portion 122 of the inner main body portion 120-in, a leg portion of a second pocket guide segment 130-2 is inserted into an outer side of the receiving portion 122 of the inner main body portion 120-in, a leg portion of a third pocket guide segment 130-3 is inserted into an inner side of the receiving portion 122 of the outer main body portion 120-out, and a leg portion of a fourth pocket guide segment 130-4 is received into an outer side of the receiving portion 122 of the outer main body portion 120-out, respectively.

FIGS. 6, 7 and 8 show an application example in which the structure shown in FIGS. 1 to 4 and 5 is designed and manufactured as an actual product. In this application example, not only the main body portion 120 of the door guide frame 100, but also a vertical guide frame 101 on both sides is also made to adopt a heat insulating structure in which an inner frame and an outer frame are connected to each other by a thermal bridge blocking member 101m disposed in the middle region between the inner frame and the outer frame, and in a vertical reinforcing member 420 having an enlarged section (a section having a thickness larger than a thickness of the glass) for compensating the lateral bending stiffness of the glass 410 is formed on both sides of a glass 410 constituting the sliding window 400, furthermore provides a specific difference in that a steel reinforcing plate 422 for reinforcing the rigidity is inserted into the inside of the vertical reinforcing member 420.

In the door guide frame of the separable and detachable segment structure for sliding windows according to the prior art described above, in the case of a first pocket guide segment 130-1 being accommodated in the inner side surface of the inner main body portion 120-in, and in the case of a fourth pocket guide segment 130-4 being accommodated in the outer surface of the outer main body portion 120-out, the entirety may be formed of an aluminum material (see FIG. 5), or only the leg portion thereof may be formed as a thermal bridge blocking member (see FIG. 6 and FIG. 7). These are housed in the receiving portion 122 of the main body portion 120 of the door guide frame 100 of the aluminum material with the two inner and outer leg portions at the lower portion to form a good supporting state as shown in the figure. On the other hand, as shown in FIG. 8, in the case of the second pocket guide segment 130-2 being accommodated in the outer surface of the inner main body portion 120-in and in the case of the third pocket guide segment 130-3 being accommodated in the inner surface of the outer main body portion 120-out, since the lower leg region 130m, formed by the heat bridge member being separated from the upper cap region 130a of the aluminum material, should be located on the heat bridge blocking member 120m connecting the inner main body portion 120-in and the outer main body portion 120-out of the main body portion 120 of the door guide frame 100, it is difficult to expect a good supporting force. Also, it is difficult to provide suitable fastening means (fitting engagement) to the thermal bridge blocking member 120m between them (making it difficult to form with the fitting engagement). Therefore, there is a high possibility that a mounting clearance is generated in a connecting part contact-K between the first pocket guide segment 130-2 and the third pocket guide segment 130-3, and if the first pocket guide segment 130-2 and the third pocket guide segment 130-3 are made with a little tolerance margin to reduce the possibility of such clearance, accordingly, it is difficult to install the other one in a state in which one of the two is installed first, and thus a poor installation condition such as the incline of the upper cap region 130a occurs.

Further, when such a poor workability is caused, friction noise due to inadequate excessive friction with the accessory guide rollers 457 provided on the side of the roller member 450 under the sliding window 400 may occur.

### DETAILED DESCRIPTION OF THE INVENTION

### Technical Problem

The present invention has been made in order to solve the problems in the prior art and a technical object of the present invention is to provide a means for providing a good supporting force for a lower leg region formed of such a heat bridge blocking member without damaging the heat insulating performance of the frame, even when the second pocket guide segment accommodated in the outer side surface of the inner main body portion and the third pocket guide segment accommodated in the inner side surface of the outer main body portion is separated from the upper cap region of the aluminum material and has the lower leg region formed of the heat bridge blocking member, in order to improve the heat insulating performance of the door guide frame, the door guide frame of the detachable and detachable segment structure for sliding windows is divided into an outer main body portion, an main inner body portion, and a heat bridge blocking member between thereof.

In addition, in achieving the above-mentioned technical problems, it is desired to simultaneously improve the heat insulating performance of the entire sliding window system and also provide a technical means for installing an additional insect-proof window.

### Technical Solution

In order to solve the above-described problems, the present invention provides door guide frame of the segmented structure for sliding windows and doors;

in the door guide frame, a pocket guide being detachably attached to a main body portion of the door guide frame, wherein the pocket guide which is laterally guided and supported on both the inner and outer sides of the sliding window is detachably installed from the main body portion of the door guide frame; the pocket guide is formed as a pocket guide segment that is detachable from the main body portion of the door guide frame; and the pocket guide segments are mutually removably installed on both the inner and outer sides of the sliding window along the traveling direction of the roller guide rail;

wherein, in a door guide frame of a separable and detachable segment structure for sliding windows and doors, in which the door guide frame is divided into an outer main body portion and an inner main body portion, a thermal bridge blocking member is disposed in the middle (between the outer main body portion and the inner main body portion), a second pocket guide segment being received in an outer surface of the inner main body portion and a third pocket guide segment being received in an inner surface of the outer main body portion are separated from an upper cap region of the aluminum material to form a lower leg region formed of a heat bridge blocking material;

the door guide frame of a separable and detachable segment structure comprising; in order to improve the heat insulation performance of the door guide frame,

an external heat bridge blocking member, one side of which is coupled to an inner side surface of the outer main body portion, and an internal heat bridge blocking member, one side of which is coupled to an external side surface of the inner main body portion; and

an intermediate connector of aluminum material having both side surfaces joined to the other side surfaces of the external heat bridge blocking member and the internal heat bridge blocking member;

and wherein, the door guide frame of a separable and detachable segment structure being characterized in that, in order to support the lower leg region formed by the heat bridge blocking material, of the second pocket guide segment received in an outer surface of the inner main body portion and the third pocket guide segment received in an inner surface of the outer main body portion, a separation support region is formed in an upper surface of the intermediate connector.

In addition, a vertical guide frame is provided in a vertical direction on both side surfaces of the main body of the door guide frame constituting the door guide frame, and the vertical guide frame is divided into an outer vertical guide frame and an inner vertical guide frame. Additionally it is possible to provide a structure in which the outer heat bridge blocking member (the outer heat bridge blocker), the connector, and the inner heat bridge blocking member (the inner heat bridge blocker) are arranged and connected between thereof. Furthermore, an insect-proof window mounting frame is additionally provided on an outer front surface of the door guide frame, and an extended outer surface extending outwardly from the outer main body portion forming the guide frame main body portion of the door guide frame, and therefore a fastening groove for the insect-proof window mounting frame may be provided on at least one outer surface of an outer surface of the outer vertical guide frame of the vertical guide frame and a extended outer surface extended from an outer surface of the outer main body forming the main body of the guide frame of the door guide frame.

### Advantageous Effects

According to the present invention, the second pocket guide segment accommodated in the outer surface of the inner main body portion and the third pocket guide segment accommodated in the inner surface of the outer main body portion are separated from the upper cap region of the aluminum material, and the intermediate connector in which the separator for separating and supporting the lower leg region formed of the heat bridge blocking member is formed without damaging the heat insulating performance of the door guide frame is provided between the external heat bridge blocking member and the internal heat bridge blocking member so that it is possible to provide a good supporting force.

In addition, it is also intended to simultaneously provide an improvement in the heat insulation performance of the entire sliding window system and also provide a technical means for installing an insect-proof window.

### BRIEF DESCRIPTION OF THE DRAWINGS

FIGS. 1 to 4 are cross-sectional views of an operating state of a sliding window installation structure including a door guide frame of a segment structure detachable and detachable according to the related art to which the present invention is applied.

FIG. 5 is a partially exploded perspective view of the position of a broken line taken along line B-B′ in FIG. 4, and is a perspective view showing an embodiment in which a sliding window installation structure is applied to an aluminum window frame system.

FIG. 6 is a cross-sectional view illustrating an application example in which the structure shown in FIG. 1 to FIG. 4 and FIG. 5.

FIG. 7 is a longitudinal sectional view of FIG. 6, and FIG. 8 is an enlarged view of a portion “A” of FIG. 7.

FIG. 9 is a cross-sectional view of a sliding window installation structure having a door guide frame of a separable and detachable segment structure according to a preferred embodiment of the present invention.

FIG. 10 is a longitudinal sectional view of the embodiment shown in FIG. 9.

FIG. 11 is an enlarged view of a portion “B” in FIG. 10.

FIG. 12 is a cross-sectional view illustrating a state in which an insect-proof window installation frame including a sliding insect-proof window is additionally installed in the embodiment shown in FIG. 9.

FIG. 13 is a longitudinal section of a further embodiment shown in FIG. 12.

FIG. 14 is an enlarged view of a portion “C” in FIG. 13.

### MODE FOR CARRYING OUT THE INVENTION

Hereinafter, embodiments of the present invention will be described with reference to the accompanying drawings such that a person ordinarily skilled in the art to which the present invention belongs may easily embody the present invention. However, the present invention may be implemented in various forms and is not limited to the embodiments described herein.

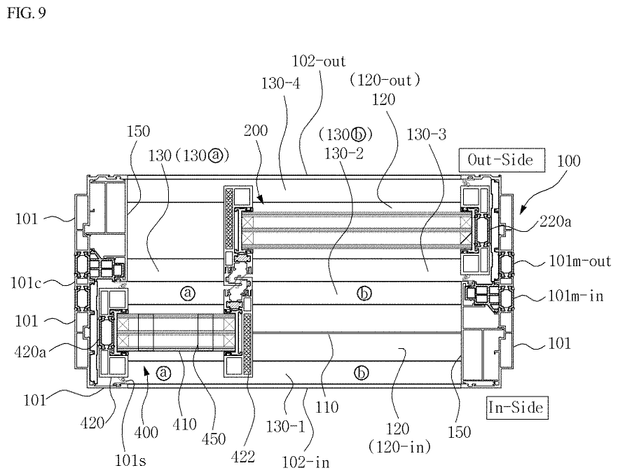

As described above, the present invention is intended to solve a problem of the prior art, FIGS. 9, 10, and 11 are cross-sectional views of an installation state of a preferred embodiment of a sliding window installation structure (a sliding window installation structure including a door guide frame of a separable and detachable segment structure) according to the basic concept of the present invention are shown, and according to a preferred embodiment of the present invention illustrated through these figures,

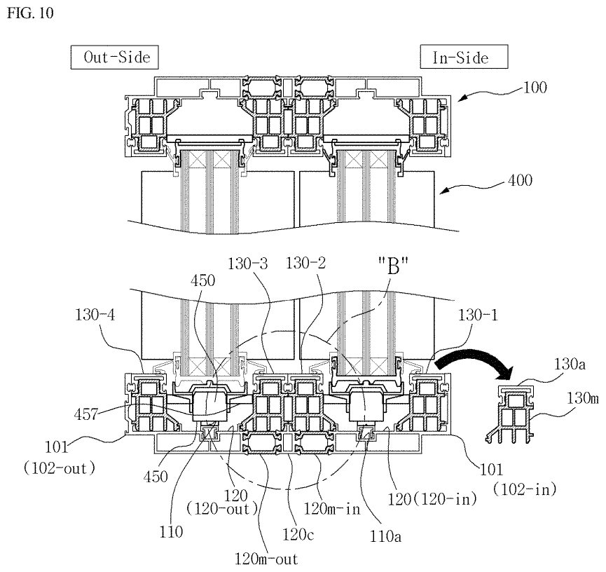

As shown in FIG. 9, in the door guide frame 100, a pocket guide 130 being detachably attached to a main body portion 120 of the door guide frame 100, wherein the pocket guide 130 which is laterally guided and supported on both the inner and outer sides of the sliding window is detachably installed from the main body portion 120 of the door guide frame 100; the pocket guide 130 is formed as a pocket guide segment (130: 130\textcircled{a} or 130\textcircled{b}) that is detachable from the main body portion 120 of the door guide frame 100; and the pocket guide segments (130: 130\textcircled{a} or 130\textcircled{b}) are mutually removably installed on both the inner and outer sides of the sliding window along the traveling direction of the roller guide rail 110;

wherein, in a door guide frame 100 of a separable and detachable segment structure for sliding windows and doors, in which the door guide frame 100 is divided into an outer main body portion 120-out and an inner main body portion 120-in, a thermal bridge blocking member 120m is disposed in the middle (between the outer main body portion and the inner main body portion), a second pocket guide segment 130-2 being received in an outer surface of the inner main body portion 120-in and a third pocket guide segment 130-3 being received in an inner surface of the outer main body portion 120-out are separated from an upper cap region of the aluminum material to form a lower leg region 130m formed of a heat bridge blocking material, as shown FIG. 10;

the door guide frame 100 of a separable and detachable segment structure comprising; in order to improve the heat insulation performance of the door guide frame,

an external heat bridge blocking member 120m-out, one side of which is coupled to an inner side surface of the outer main body portion 120-out, and an internal heat bridge blocking member 120m-in, one side of which is coupled to an external side surface of the inner main body portion 120-in; and

an intermediate connector 120c of aluminum material having both side surfaces joined to the other side surfaces of the external heat bridge blocking member 120m-out and the internal heat bridge blocking member 120m-in;

and wherein, the door guide frame of a separable and detachable segment structure being characterized in that, in order to support the lower leg region 130m-f formed by the heat bridge blocking material, of the second pocket guide segment 130-2 received in an outer surface of the inner main body portion 120-in and the third pocket guide segment 130-3 received in an inner surface of the outer main body portion 120-out, a separation support region 120ct is formed in an upper surface of the intermediate connector 120c.

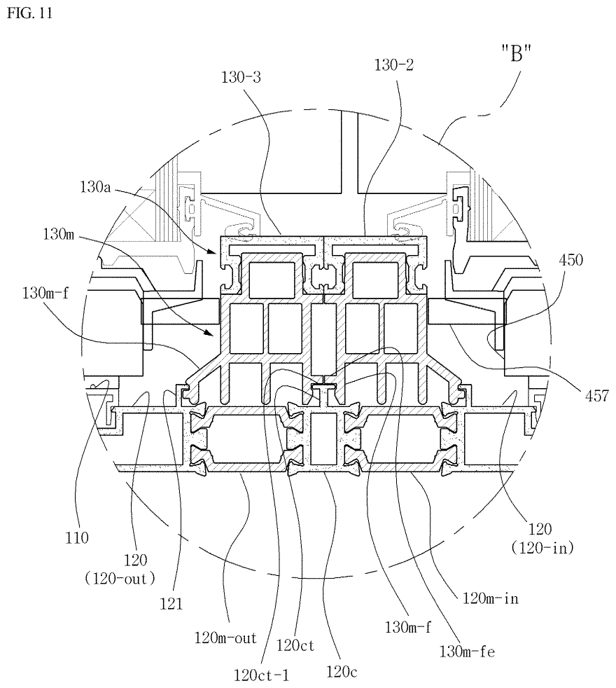

Here, as shown in an enlarged view of FIG. 11, it is preferable that the separation supporting part 120ct is formed integrally upwardly from the upper surface of the intermediate connector 120c and an upper supporting part 120ct-1 of the separation supporting part 120ct is formed wider than the lower protruding part. Also, it is preferable that seating projections 130m-fe, which is formed in the upper support portion 120ct-1 of the separation support portion 120ct, the seating protrusion 130m-fe is formed on the upper surface of the second pocket guide segment 130-2 and the third pocket guide segment 130-3 and is protruded sideward from the lower leg region 130m-f formed of the heat bridge blocking member, are seated and supported facing each other.

Meanwhile, according to a more preferred embodiment of the present invention, as shown in FIG. 9, a vertical guide frame 101 installed vertically on both sides of the main body 120 constituting the door guide frame 100 is divided into an outer vertical guide frame and an inner vertical guide frame, it is preferable to arrange and connect an outer side heat bridge blocking member 101m-out, a connector 101c, and an inner side heat bridge blocking member 101m-in between them, therefore the outer side heat bridge blocking member 101m-out, the connector 101c, and the inner side heat bridge blocking member 101m-in are respectively connected to the outer heat bridge blocking member 120m-out of the main body 120 of the door guide frame, the intermediate connector 120c, and the inner heat bridge blocking member 120m-in, so as to improve the heat insulation performance of the entire sliding window system.

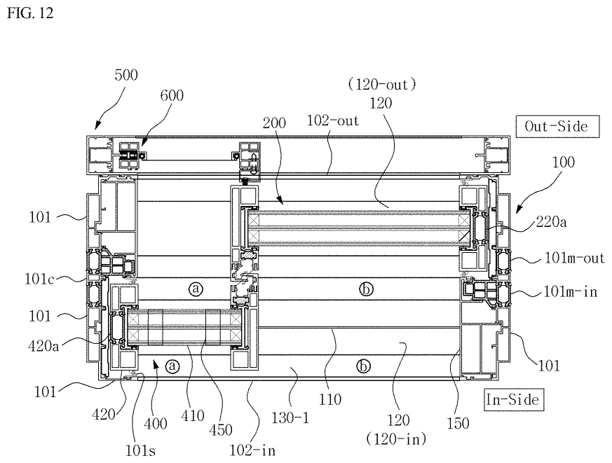

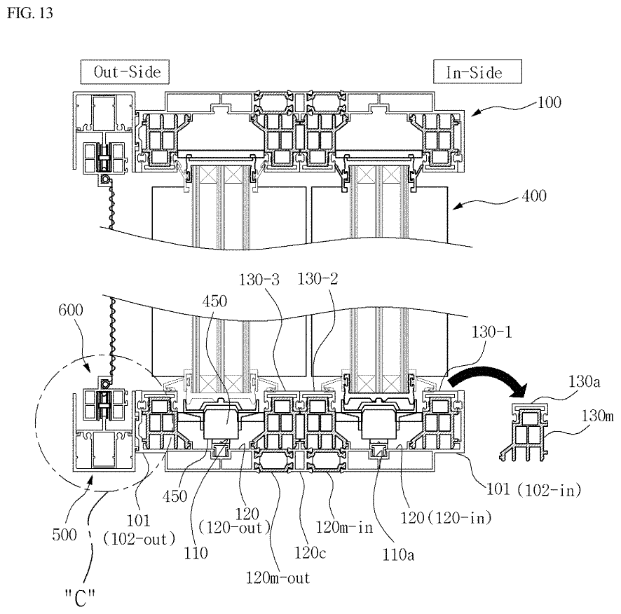

In addition, according to a further preferred embodiment of the present invention, as shown in FIGS. 12 to 14, in order to additionally provide an insect-proof window installation structure in the sliding window system, at an outer front surface of the door guide frame 100, in order to allow the sliding insect-proof window 600 to be integrally installed into an insect-proof window installation frame 500 and to be able to separate an installed sliding insect-proof window 600 from the insect-proof window installation frame 500, an insect-proof window installation frame 500 is additionally provided, wherein the insect-proof window installation frame 500 comprises;

an insect-proof screen mounting frame main body pocket 510 installed in a pocket shape;

a rail 522 extending along the sliding movement direction of the sliding insect-proof window 500 at a position having a predetermined distance from the bottom surface or the ceiling of the insect-proof screen installation main body portion pocket 510; and

a rail bridge 520 detachably inserted into the insect-proof screen installation main body portion pocket 510.

Further, a fastening groove 101a for the insect-proof window mounting frame may be provided on at least one outer surface of an outer surface of the outer vertical guide frame of the vertical guide frame 101 and a extended outer surface 102-out extended from an outer surface of the outer main body 120-out forming the main body 120 of the guide frame of the door guide frame 100, and it is preferable that a fastening protrusion 501 that can be engaged with the fastening groove 101a is protruded from the insect-proof screen installation main body portion pocket 510.

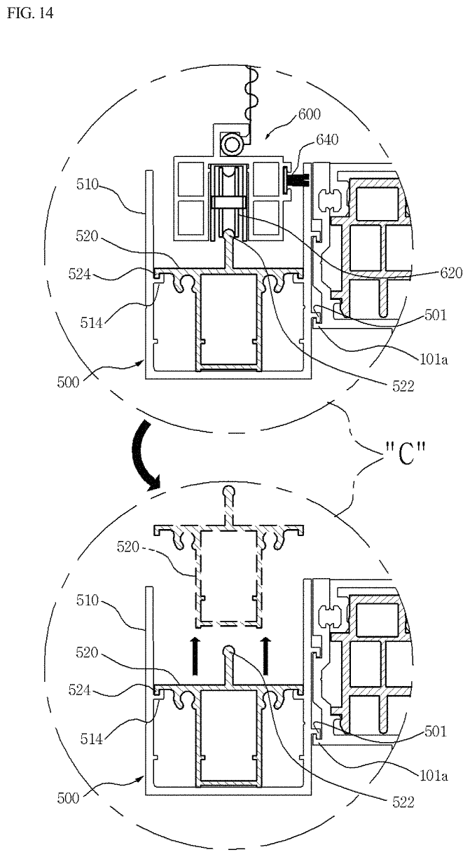

As shown in FIG. 14, an inner side of the insect-proof screen mounting frame main body part pocket 510 is preferably provided with a latching end 514 protruding and formed along a traveling direction of the rail 522. At both inner and outer ends of the rail bridge 520, it is preferable that an engagement protrusion 524 which is fitted to the latching end 514 is provided along the traveling direction of the rail 522. The rail bridge 520 is prevented from separating from the insect-proof screen installation main body portion pocket 510 unless a predetermined frictional force is generated and an external force is applied at a portion where the latching end 514 and the engagement protrusion 524 are engaged, it is preferable that the rail 522 is protruded from the upper surface of the rail bridge 520 and is easily detached and separated when the rail 522 is gripped and pulled.

The rail bridge 520 may be formed of two or more rail bridge segments detachable from the inside of the insect-proof screen installation main body portion pocket 510.

It should be understood by those skilled in the art that a single window 200 other than the sliding window 400 is illustrated in the form of a fixed window in the drawings, but may be a sliding window other than a fixed window within the scope of the present invention. It will be obvious.

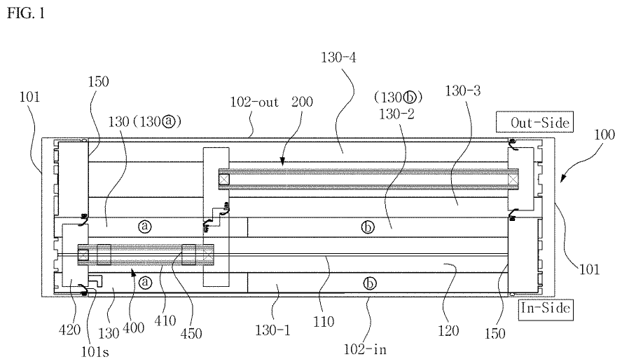

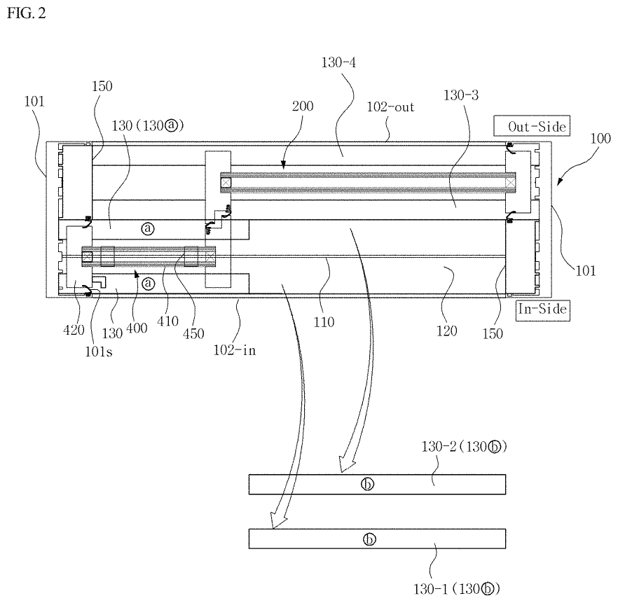

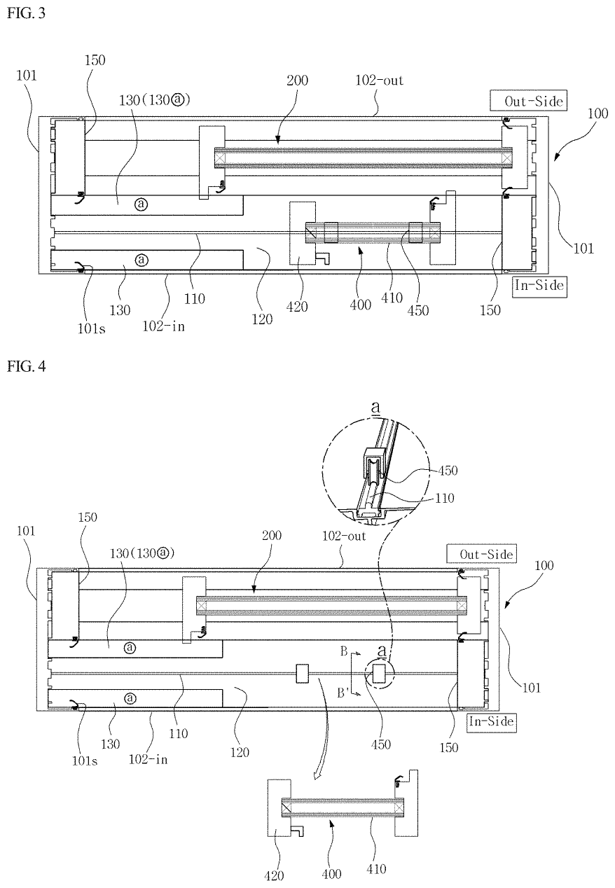

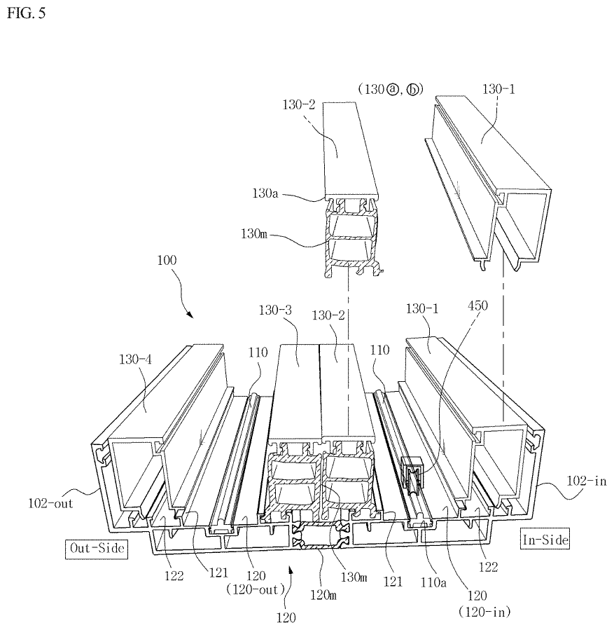

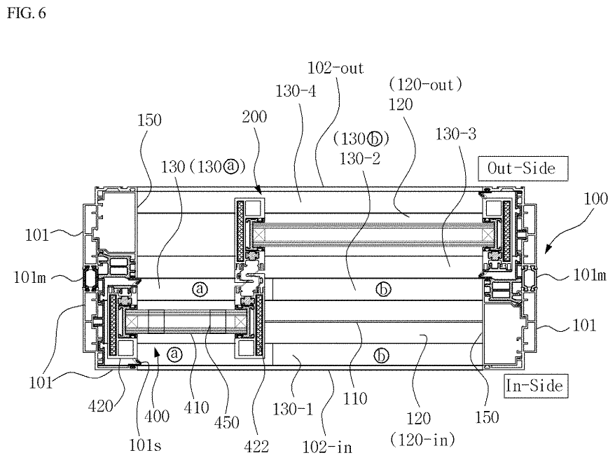

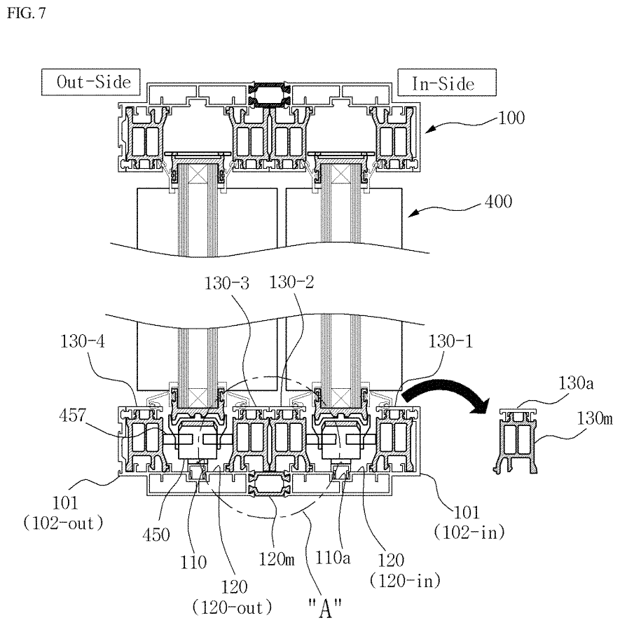

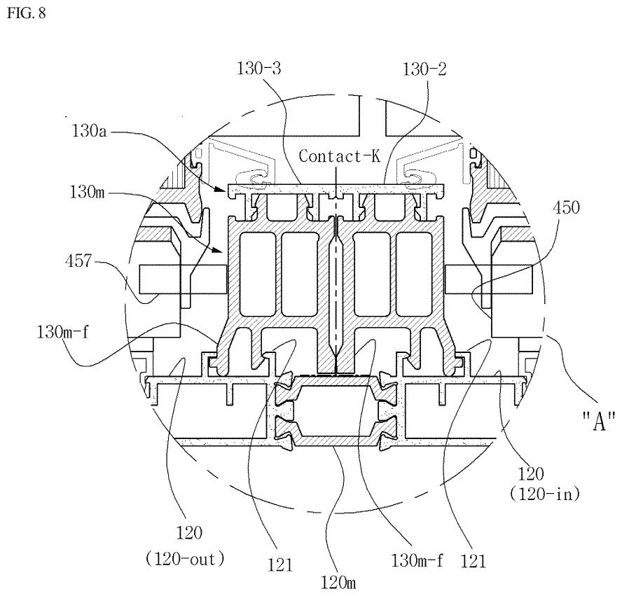

According to the basic concept of the present invention, the pocket guide segments 130\textcircled{a} and 130\textcircled{b} supporting the sliding window 400 can be removed from the door guide frame 100, separation from the door guide frame 100 or installation on the door guide frame 100 may be performed, which process is substantially the same as the process outlined in FIGS. 1 to 4 of the accompanying drawings. The entire structure and operation of the present invention are described in Korean Patent Application No. 10-2012-0047789 (Korean Patent Registration No. 10-1367835) filed by the inventor of the present invention and PCT Application No. PCT/KR2013/003912 published in a laid-open Publication No. WO 2013/168943A1), which is incorporated herein by reference in its entirety.

However, the scope of the present invention to be protected is not limited thereto and may cover various types of sliding windows (door or window) to which the present invention is applied, and various modifications and changes using the basic concept of the present invention defined in the accompanying claims also belong to the scope of the present invention.

1. A door guide frame of detachable segment structure for sliding windows and doors,
in the door guide frame 100, a pocket guide 130 being detachably attached to a main body portion 120 of the door guide frame 100, wherein the pocket guide 130 which is laterally guided and supported on both the inner and outer sides of the sliding window is detachably installed from the main body portion 120 of the door guide frame 100; the pocket guide 130 is formed as a pocket guide segment (130: 130\textcircled{a} or 130\textcircled{b}) that is detachable from the main body portion 120 of the door guide frame 100; and the pocket guide segments (130: 130\textcircled{a} or 130\textcircled{b}) are mutually removably installed on both the inner and outer sides of the sliding window along the traveling direction of the roller guide rail 110;
wherein, in a door guide frame 100 of a separable and detachable segment structure for sliding windows and doors, in which the door guide frame 100 is divided into an outer main body portion 120-out and an inner main body portion 120-in, a thermal bridge blocking member 120m is disposed in the middle (between the outer main body portion and the inner main body portion), a second pocket guide segment 130-2 being received in an outer surface of the inner main body portion 120-in and a third pocket guide segment 130-3 being received in an inner surface of the outer main body portion 120-out are separated from an upper cap region of the aluminum material to form a lower leg region 130m formed of a heat bridge blocking material;
the door guide frame 100 of a separable and detachable segment structure comprising; in order to improve the heat insulation performance of the door guide frame,
an external heat bridge blocking member 120m-out, one side of which is coupled to an inner side surface of the outer main body portion 120-out, and an internal heat bridge blocking member 120m-in, one side of which is coupled to an external side surface of the inner main body portion 120-in; and
an intermediate connector 120c of aluminum material having both side surfaces joined to the other side surfaces of the external heat bridge blocking member 120m-out and the internal heat bridge blocking member 120m-in;
and wherein, the door guide frame of a separable and detachable segment structure being characterized in that, in order to support the lower leg region 130m-f formed by the heat bridge blocking material, of the second pocket guide segment 130-2 received in an outer surface of the inner main body portion 120-in and the third pocket guide segment 130-3 received in an inner surface of the outer main body portion 120-out, a separation support region 120ct is formed in an upper surface of the intermediate connector 120c.

2. The door guide frame of detachable segment structure for sliding windows and doors of claim 1, characterized in that
the separation supporting part 120ct is formed integrally upwardly from the upper surface of the intermediate connector 120c and an upper supporting part 120ct-1 of the separation supporting part 120ct is formed wider than the lower protruding part.

3. The door guide frame of detachable segment structure for sliding windows and doors of claim 2, characterized in that
seating projections 130m-fe is formed in the upper support portion 120ct-1 of the separation support portion 120ct, the seating protrusion 130m-fe is formed on the upper surface of the second pocket guide segment 130-2 and the third pocket guide segment 130-3 and is protruded sideward from the lower leg region 130m-f formed of the heat bridge blocking member, are seated and supported facing each other.

4. The door guide frame of detachable segment structure for sliding windows and doors of claim 3, characterized in that
a vertical guide frame 101 installed vertically on both sides of the main body 120 constituting the door guide frame 100 is divided into an outer vertical guide frame and an inner vertical guide frame, and
an outer side heat bridge blocking member 101m-out, a connector 101c, and an inner side heat bridge blocking member 101m-in between them are arranged, and
the outer side heat bridge blocking member 101m-out, the connector 101c, and the inner side heat bridge blocking member 101m-in are respectively connected to the outer heat bridge blocking member 120m-out of the main body 120 of the door guide frame, the intermediate connector 120c, and the inner heat bridge blocking member 120m-in.

5. The door guide frame of detachable segment structure for sliding windows and doors of claim 4, characterized in that
in order to additionally provide an insect-proof window installation structure in the sliding window system, at an outer front surface of the door guide frame 100, in order to allow the sliding insect-proof window 600 to be integrally installed into an insect-proof window installation frame 500 and to be able to separate an installed sliding insect-proof window 600 from the insect-proof window installation frame 500, an insect-proof window installation frame 500 is additionally provided, wherein the insect-proof window installation frame 500 comprises;
an insect-proof screen mounting frame main body pocket 510 installed in a pocket shape;
a rail 522 extending along the sliding movement direction of the sliding insect-proof window 500 at a position having a predetermined distance from the bottom surface or the ceiling of the insect-proof screen installation main body portion pocket 510; and
a rail bridge 520 detachably inserted into the insect-proof screen installation main body portion pocket 510; and
a fastening groove 101a for the insect-proof window mounting frame is provided on at least one outer surface of an outer surface of the outer vertical guide frame of the vertical guide frame 101 and a extended outer surface 102-out extended from an outer surface of the outer main body 120-out forming the main body 120 of the guide frame of the door guide frame 100, and that a fastening protrusion 501 being engaged with the fastening groove 101a is protruded from the insect-proof screen installation main body portion pocket 510.
